(19) United States
(12) Patent Application Publication
(10) Pub. No.: US 2013/0191190 A1
(43) Pub. Date: Jul. 25, 2013

(54) METHOD AND SYSTEM FOR MOTIVATING AND OPTIMIZING USAGE OF HIGH OCCUPANCY VEHICLE/HIGH OCCUPANCY TOLL LANE BY DISPLAYING TIME BASED COST METRICS

(71) Applicants: Barry P. Mandel, Faiport, NY (US); Rakesh Kulkarni, Webster, NY (US)

(72) Inventors: Barry P. Mandel, Faiport, NY (US); Rakesh Kulkarni, Webster, NY (US)

(73) Assignee: XEROX CORPORATION, Norwalk, CT (US)

(21) Appl. No.: 13/354,803

(22) Filed: Jan. 20, 2012

(51) Int. Cl. G06Q 50/30

(52) U.S. Cl. 705/13

(57) ABSTRACT

A method and system for motivating and optimizing usage of a toll lane by displaying a time based cost metric on an electronic display. The real time electronic display can be configured on the toll lane for displaying information with respect to the toll lane to, for example, a driver on a highway. An average speed of vehicles in the toll lane and/or a non-toll lane of the highway over at least one span can be measured and the average speed can be displayed on the electronic display. A toll rate with respect to the usage of the toll lane can be determined and displayed. A time saving value and a cost per unit time with respect to the usage of the toll lane over the span can be calculated and displayed on the electronic display.

### TECHNICAL FIELD

Embodiments are generally related to HOV (High Occupancy Vehicle) lanes and traffic management. Embodiments are also generally related to HOT (High Occupancy Toll) lanes. Embodiments are additionally related to managing and optimizing the usage of HOV-HOT lanes.

### BACKGROUND OF THE INVENTION

Traffic congestion is a condition on a road network that occurs as use increases and is characterized by slower speeds, longer trip times, and increased vehicular queuing. Several travel demand management techniques have been employed to alleviate traffic congestion. For example, HOV (High Occupancy Vehicle) lanes and/or carpool lanes can be employed to encourage people to share rides, and thus decrease the amount of vehicles on the roads.

HOT (High Occupancy Toll) lanes typically involve a road pricing scheme that provides motorists in a single-occupant vehicle access to the HOV lanes. Sometimes, entire roads can be designated for the use of HOVs. Tolls can be collected either by a manned toll booth, automatic number plate recognition, or an electronic toll collection system. Typically, these tolls increase as traffic density and congestion within the tolled lanes increases, a policy known as congestion pricing. The goal of this pricing scheme is to encourage optimal use of the HOV lane and to minimize traffic congestion within the lanes.

Conventional highways system includes an electronic display that displays the HOV/HOT toll fee and/or expected commute times. FIG. 1, for example, illustrates an electronic display 100 that displays only the expected commute times 110 on two highways and current toll rate 120. As indicated in the example configuration shown in FIG. 1, an electronic display 100 is not effectively displaying information in a way that simplifies each driver's decision making which can lead to the traffic congestion problems. Furthermore, the electronic display 100 is not predictive of an oncoming traffic condition that may also result in traffic congestion problems if not sufficiently addressed in time. The electronic display 100 does not display time savings and costs per unit time with respect to the usage of the HOV/HOT lanes and do not motivate a driver to make full use of their capacity to maximize revenue and/or to minimize the commute times in the HOV/HOT lanes.

Based on the foregoing, it is believed that a need exists for an improved method and system for motivating and optimizing usage of a HOV/HOT lane by displaying a time based cost metric, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved HOV (High Occupancy Vehicle) lane enforcement method and system.

It is another aspect of the disclosed embodiments to provide for an improved HOT (High Occupancy Toll) lane enforcement method and system.

It is a further aspect of the disclosed embodiments to provide for an improved method and system for motivating and optimizing usage of a HOV/HOT lane by displaying a time based cost metric.

The aforementioned aspects and other objectives and advantages can now be achieved as described herein. A method and system for motivating and optimizing usage of a toll lane (e.g., HOV/HOT lane) by displaying a time based cost metric on an electronic display is disclosed herein. The real time electronic display can be configured on the toll lane for displaying information with respect to the toll lane to a driver on a highway. An average speed of the vehicle in the toll lane and/or a non-toll lane of the highway over at least one span can be measured and the average speed can be displayed on the electronic display. A toll rate with respect to the usage of the toll lane over the span can be determined and displayed on the electronic display. A time saving value and a cost per unit time with respect to the usage of the toll lane over the span can be calculated and displayed on the electronic display.

The average speed on the HOV/HOT lane can be measured by utilizing a sensor, an image capturing device, and/or GPS information from a mobile communication device in the vehicle on the highway. The time saving value and the cost per unit time can be updated dynamically based on a real time measurement of the vehicle's speed and the toll rate. The electronic display shows the time savings and the cost per unit time for a commute of a specified distance. The electronic display also displays the time savings and cost per unit time for at least one specific destination along the highway to optimize the toll fees and/or usage of the HOT lane. The cost per hour can be compared with a reference threshold (thresholds can even vary by location) and a color coding can be employed on the display. A motivational message with respect to the usage of the HOV/HOT lane can be also displayed. A color of at least one portion of the displayed message can be changed based on the value of the calculated time based metric.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a road system having an electronic display that displays expected commute times on two highways and toll rate;

FIG. 2 illustrates a block diagram of a traffic lane management system for motivating and optimizing usage of a toll lane, in accordance with the disclosed embodiments;

FIG. 3 illustrates a schematic diagram of a road system having an electronic display that displays time based cost metric, in accordance with the disclosed embodiments;

FIG. 4 illustrates a perspective of an electronic display that displays time based cost metric, in accordance with the disclosed embodiments; and

FIG. 5 illustrates a high level flow chart of operations illustrating logical operational steps of a method for motivating and optimizing usage of the toll lane by displaying a time based cost metric on an electronic display, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

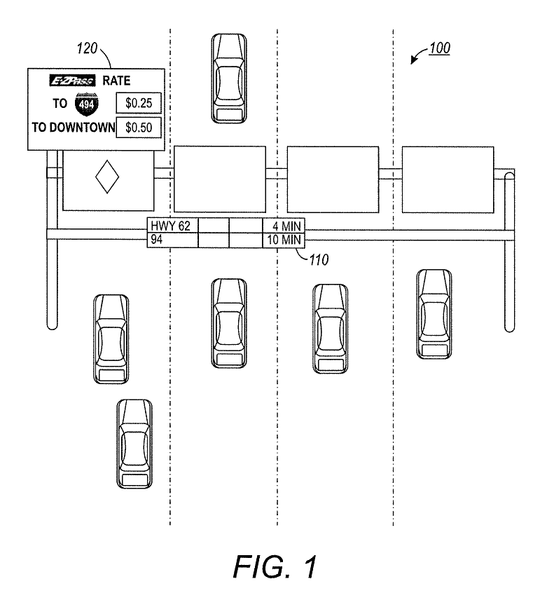

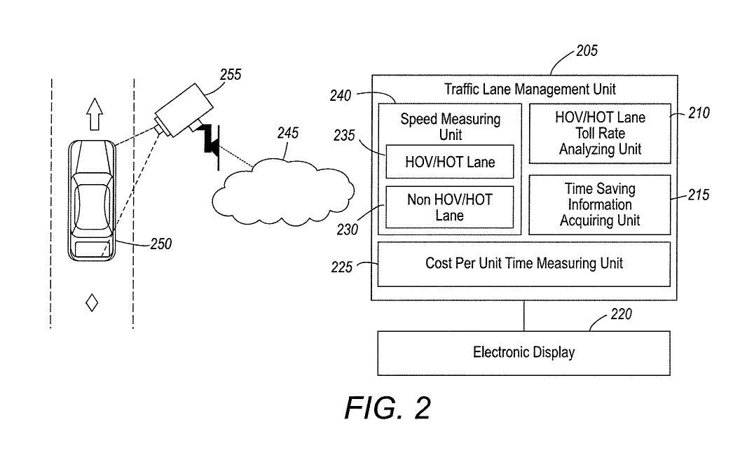

FIG. 2 illustrates a block diagram of a traffic lane management system for motivating and optimizing usage of a toll lane, in accordance with the disclosed embodiments. Note that in FIGS. 1-5, identical or similar blocks are generally indicated by identical reference numerals. The toll lane can be, for example, a HOV (High Occupancy Vehicle) lane or a HOT (High Occupancy Toll) lane. HOV lane, also known as the carpool or diamond lane, is a traffic management strategy to promote and encourage ridesharing; thereby alleviating congestion and maximizing the people-carrying capacity of highways. HOV lane is usually located on the inside (left) lane and is identified by signs along the freeway and white diamond symbols painted on the pavement. The HOV lanes may be transformed into HOT lanes and the HOT lanes may be used by single-occupancy vehicles that are willing to pay a toll charge to save driving time.

The traffic lane management system includes a traffic lane management unit 205 for motivating and optimizing usage of the HOV-HOT lane 235. The traffic lane management unit 205 includes a real time electronic display 220 for displaying information with respect to the HOV/HOT lane 235 to a driver on a highway. The traffic lane management unit 205 further includes a speed measuring unit 240, a HOV/HOT lane toll rate analyzing unit 210, a time saving information acquiring unit 215, and a cost per unit time measuring unit 225. In general, electronic display 220 (e.g., also referred to as “electronic signs” or “electronic signage”) comprises illuminant-advertising media utilized in the signage industry. Electronic signage includes, for example, fluorescent signs, HID (High Intensity Displays), incandescent signs, LED signs, neon signs, and so forth. Additionally, LED signs and HID also generally constitute so-called digital signage.

The speed-measuring unit 240 can measure the average speed of a vehicle 250 in the HOV/HOT lane 235 and/or non-HOT/HOV lane 230 of the highway over at least one span and the average speed can be displayed on the electronic display 220. Note that the average speed on the HOV/HOT lane 235 can be measured by utilizing a sensor, an image capturing device 255, and/or GPS information from a mobile communication device in the vehicle 250 on the highway depending upon design considerations. The image capturing device 255 may receive traffic information such as, for example, traffic speed and traffic flow on each of the HOV/HOT lane 235 and/or non-HOT/HOV lane 230 and communicate the information to the traffic lane management unit 205 via a wired or wireless network connection 245. The traffic lane management unit 205 can be coupled to an electronic display 220 that is located near the HOV/HOT lane 235 to notify motorists of the time based cost metric.

The HOV/HOT lane toll rate analyzing unit 210 analyzes a toll rate for use of the HOV/HOT lane 235 over the span and the toll rate can be displayed on the electronic display 220. Note that the toll charge can be calculated and updated every 5 minutes, 10 minutes, or any other suitable user-defined interval, and can be displayed on the electronic display 220. The time saving information acquiring unit 215 calculates a time savings with respect to usage of the HOV/HOT lane 235 and the cost per unit time measuring unit 225 measures a cost per unit time with respect to usage of the HOV/HOT lane 235 over the span. The time saving information and the cost per unit time can be displayed on the electronic display 220.

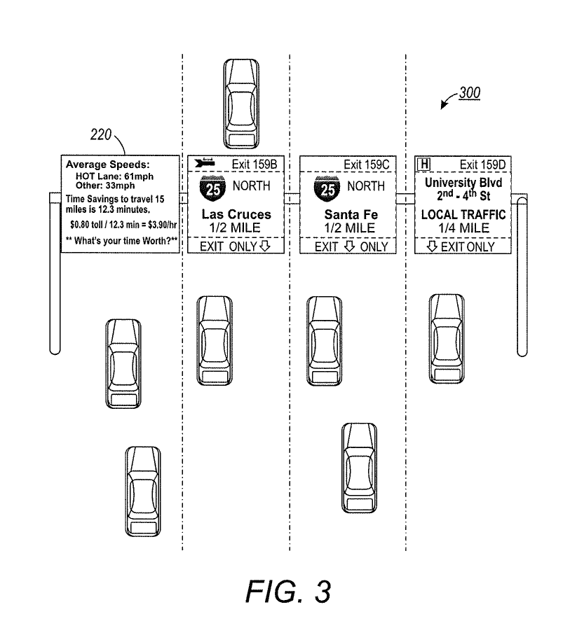

FIG. 3 illustrates a schematic diagram of a road system 300 having the electronic display 220 that displays time based cost metric, in accordance with the disclosed embodiments. The HOV/HOT lane 235 can be separated from the non-HOT/HOV lane 230 by a median barrier or other suitable separating structure. The electronic display 220 can be located near the HOV/HOT lane 235 to notify motorists of the time based cost metric for using the HOV/HOT lane 235. The toll charge may vary depending on the traffic conditions of the HOV/HOT lane 235 and non-HOT/HOV lane 230. Note that the number of HOV/HOT lane 235 and non-HOT/HOV lane 230, number of segments, and distance of the segments may vary depending on the design requirements and constraints of the road segment.

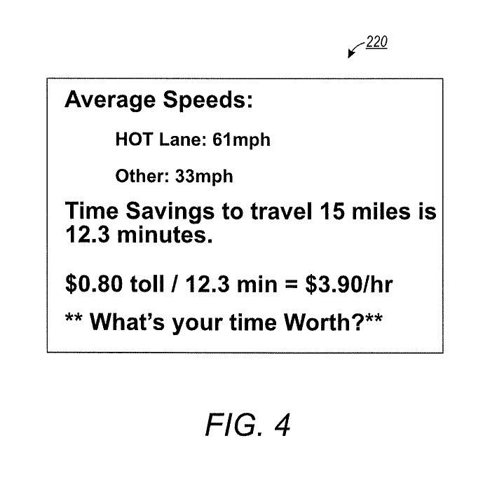

FIG. 4 illustrates a perspective view of the electronic display 220 that displays time based cost metric, in accordance with the disclosed embodiments. The time delta and cost per unit time can be updated dynamically based on a real time measurement of the vehicle speed and a toll rate. The electronic display 220 displays the time savings and the cost per unit time for a commute of a specified distance. The electronic display 220 also displays the time savings and cost per unit time for at least one specific destination along the highway to optimize the toll fees or usage of the HOT lane 235. The cost per hour can be compared with a reference threshold (thresholds can even vary by location) and a color coding can be used on the electronic display 220. For example, if the cost per hour figure is below a given threshold it can be displayed in green and the cost per hour figure is above the threshold it can be displayed in orange. The potential savings displayed in cost per unit of time with a comparison may assist the drivers to make better decisions. A motivational message with respect to the usage of the HOV/HOT lane can be also displayed on the display 220. A color of at least one portion of the displayed message can be changed based on the value of the calculated time based metric.

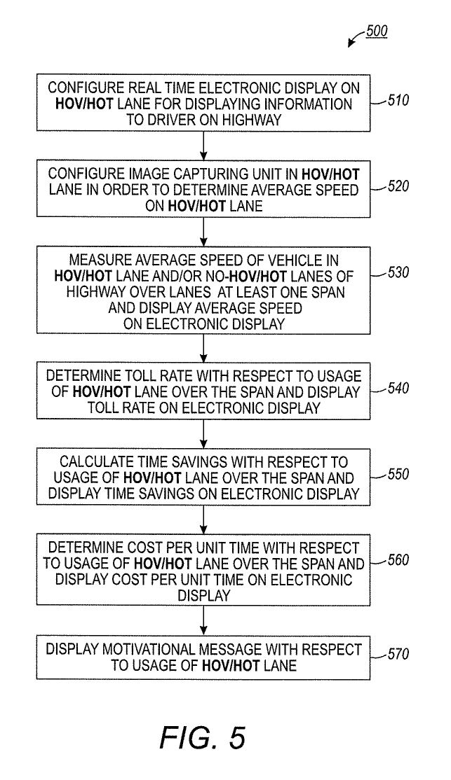

FIG. 5 illustrates a high level flow chart of operations illustrating logical operational steps of a method 500 for motivating and optimizing a HOV/HOT lane by displaying a time based cost metric on an electronic display, in accordance with the disclosed embodiments. Initially, the real time electronic display 220 can be configured on the HOV/HOT lane 235 for displaying information to the driver on the highway, as indicated at block 510. The image capturing unit 255 can be configured in the HOV/HOT lane 235 in order to determine the average speed on the HOV/HOT lane 235, as depicted at block 520. An average speed of the vehicle in the HOV/HOT lane 235 and/or a non-HOT/HOV lane 230 of the highway over at least one span can be measured and displayed on the electronic display 220, as shown at block 530.

The toll rate with respect to the usage of the HOV/HOT lane 235 over the span can be determined and displayed on the electronic display 220, as illustrated at block 540. Thereafter, as shown at block 550, the time saving with respect to the usage of the HOV/HOT lane 235 over the span can be calculated and displayed on the electronic display 220. The cost per unit time with respect to the usage of the HOV/HOT lane 235 over the span can be calculated and displayed on the electronic display 220, as shown at block 560. The motivational message with respect to usage of the HOV/HOT lane 235 can also be displayed on the electronic display 220, as illustrated at block 570. It should be noted that the calculated cost per unit time could also be used as an input parameter that could be used to define the current toll rate. In other words, the toll rate could be adjusted in real time to achieve a cost per unit time that could motivate drivers to select or not to select to drive in the HOT lane.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for motivating and optimizing usage of a toll lane, said method comprising:
associating an electronic display with a toll lane for displaying information regarding said toll lane;
measuring an average speed of at least one vehicle in said toll lane and/or a non-toll lane with respect to said highway over at least one span to thereafter display via said electronic display said average speed of said at least one vehicle;
determining a toll rate with respect to a usage of said toll lane over said at least one span in order to thereafter display said toll rate on said electronic display; and
calculating a time saving value and a cost per unit time with respect to said usage of said toll lane over said at least one span for display of said time saving value and said cost per unit time via said electronic display.

2. The method of claim 1 wherein said toll lane comprises a high occupancy vehicle lane.

3. The method of claim 1 wherein said toll lane comprises a high occupancy toll lane.

4. The method of claim 1 further comprising measuring said average speed on said toll lane utilizing at least one of the following types of devices:
a sensor;
an image capturing device; and
GPS information from a mobile communication device in at least one said vehicle on said highway.

5. The method of claim 1 further comprising dynamically updating said time saving value and said cost per unit time based on a real time measurement of said vehicle speed and said toll rate.

6. The method of claim 1 further comprising displaying said time saving value and said cost per unit time on said electronic display for a commute of a specified distance and at least one specific destination along said highway to optimize said toll rate and usage of said toll lane.

7. The method of claim 1 further comprising comparing said cost per unit time with a reference threshold and displaying said cost per unit time utilizing a color coding technique.

8. The method of claim 1 further comprising displaying a motivational message with respect to usage of said toll lane on said electronic display.

9. The method of claim 1 further comprising changing a color of at least one portion of said displayed message based on a value of said information.

10. The method of claim 1 wherein a calculated cost per unit time is utilized to dynamically update said toll rate.

11. A system for motivating and optimizing usage of a toll lane, said system comprising:
a processor;
a data bus coupled to said processor; and
a computer-usable medium embodying computer code, said computer-usable medium being coupled to said data bus, said computer program code comprising instructions executable by said processor and configured for:
associating an electronic display with a toll lane for displaying information regarding said toll lane;
measuring an average speed of at least one vehicle in said toll lane and/or a non-toll lane with respect to said highway over at least one span to thereafter display via said electronic display said average speed of said at least one vehicle;
determining a toll rate with respect to a usage of said toll lane over said at least one span in order to thereafter display said toll rate on said electronic display; and
calculating a time saving value and a cost per unit time with respect to said usage of said toll lane over said at least one span for display of said time saving value and said cost per unit time via said electronic display.

12. The system of claim 11 wherein said instructions are further configured for measuring said average speed on said toll lane utilizing at least one of the following types of devices:
a sensor;
an image capturing device; and
global positioning system information from a mobile communication device in at least one said vehicle on said highway.

13. The system of claim 11 wherein said instructions are further configured for dynamically updating said time saving value and said cost per unit time based on a real time measurement of said vehicle speed and said toll rate.

14. The system of claim 11 wherein said instructions are further configured for displaying said time saving value and said cost per unit time on said electronic display for a commute of a specified distance and at least one specific destination along said highway to optimize said toll rate and usage of said toll lane.

15. The system of claim 11 wherein said instructions are further configured for comparing said cost per unit time with a reference threshold and displaying said cost per unit time utilizing a color coding technique.

16. A processor-readable medium storing code representing instructions to cause a process to perform a process to motivate and optimize usage of a toll lane, said code comprising code to:
associate an electronic display with a toll lane for displaying information regarding said toll lane:
measure an average speed of at least one vehicle in said toll lane and/or a non-toll lane with respect to said highway over at least one span to thereafter display via said electronic display said average speed of said at least one vehicle;
determine a toll rate with respect to a usage of said toll lane over said at least one span in order to thereafter display said toll rate on said electronic display; and
calculate a time saving value and a cost per unit time with respect to said usage of said toll lane over said at least one span for display of said time saving value and said cost per unit time via said electronic display.

17. The processor-readable medium of claim 16 wherein said code further comprises code to:
dynamically update said time saving value and said cost per unit time based on a real time measurement of said vehicle speed and said toll rate;
display said time saving value and said cost per unit time on said electronic display for a commute of a specified distance and at least one specific destination along said highway to optimize said toll rate and usage of said toll lane; and
compare said cost per unit time with a reference threshold and displaying said cost per unit time utilizing a color-coding technique.

18. The processor-readable medium of claim 16 wherein said toll lane comprises a high occupancy vehicle lane.

19. The processor-readable medium of claim 16 wherein said toll lane comprises a high occupancy toll lane.

20. The processor-readable medium of claim 17 wherein a calculated cost per unit time is utilized to dynamically update said toll rate.
